(19) United States
(12) Patent Application Publication
(10) Pub. No.: US 2025/0307207 A1
(43) Pub. Date: Oct. 2, 2025

(54) System and Method for Bounding Volume Hierarchy Construction

(71) Applicant: Advanced Micro Devices, Inc., Santa Clara, CA (US)

(72) Inventors: Matthaeus G. Chajdas, Unterfoehring (DE); John Stephen Junkins, Bend, OR (US); Christopher J. Brennan, Holden, MA (US); Max Oberberger, Garching (DE)

(21) Appl. No.: 18/619,334

(22) Filed: Mar. 28, 2024

(51) Int. Cl. G06F 15/80; G06F 9/38

(52) U.S. Cl. CPC G06F 15/8023; G06F 9/3887

(57) ABSTRACT

Systems and methods for faster BVH building that requires repeated sorting and partitioning of are described. Specific hardware circuitries are programmed to sort partitioned data and make reductions for each partition. The hardware units perform the initial sorting along a split axis and calculation of bounding box extents. The solutions presented herein improve performance of BVH builds, especially for cases where the geometry is comprised of many small BVH treelets. The most expensive processing steps in BVH construction are delegated to hardware thereby minimizing memory access latencies and increasing overall system efficiencies.

### BACKGROUND

### Description of the Related Art

Bounding Volume Hierarchy (BVH) construction is a fundamental technique in computer graphics and computational geometry used to accelerate ray tracing, collision detection, and other spatial queries. The process involves partitioning a scene's objects into a hierarchical tree structure of bounding volumes, typically axis-aligned bounding boxes (AABBs). Initially, the process recursively divides the objects into smaller groups until a termination condition is met, forming a binary tree where each node represents a bounding volume encompassing its children. BVH construction aims to maximize spatial coherence within each node, minimizing traversal costs during spatial queries. Efficient BVH construction methods strive to balance the trade-off between construction time and resulting acceleration structure quality, crucial for real-time rendering and interactive simulations.

During construction of a BVH, or other hierarchical structures, sorting and reduction of primitive clusters play crucial roles in optimizing the structure for efficient spatial queries. Sorting involves arranging primitives based on a chosen criterion, often centroid distance or axis-aligned bounding box (AABB) surface area, to promote spatial coherence within clusters. This process facilitates effective binary tree construction, where primitives with close proximity or similar spatial characteristics are grouped together within the hierarchy. Reduction further refines the hierarchy by merging adjacent clusters or nodes to minimize traversal overhead. By combining neighboring clusters with similar properties, the BVH achieves a compact structure, enhancing spatial locality and accelerating ray tracing or collision detection operations.

Performing sorting and reduction operations using software can have certain disadvantages. First, software-based sorting and reduction processes typically incur computational overhead, especially for large datasets, which can significantly increase construction time. The complexity of these processes may also limit their scalability, making them less suitable for real-time or interactive applications where efficiency is important. Second, software-based approaches may not fully exploit hardware acceleration capabilities, such as parallel processing units found in GPUs, which could otherwise expedite the sorting and reduction process. Furthermore, the implementation and optimization of software-based methods require careful consideration of various factors, including memory management and cache efficiency, which can introduce additional complexity and maintenance overhead.

In view of the above, improved systems and methods for BVH building are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 is an illustration of an implementation of a sorting circuitry and a reduction circuitry, for performing one or more operations associated with geometrical primitives.

FIG. 4 illustrates a graphical representation of grouping of primitives into clusters.

FIG. 5 illustrates an example method for building a hierarchical acceleration structure based on geometrical primitives.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for improved reduction and sorting of data clusters are disclosed. The disclosed implementations provide faster and more efficient processing of data that requires repeated sorting, partitioning of sorted data, and reduction of data clusters. The described implementations disclose specific hardware circuitries which can be used to sort partitioned data and make reductions for each partition. In various implementations, reduction of clusters using the described hardware circuitries creates a pipelined system that can output data cluster leads at the same time sorting results are generated. Further, by conducting a stable sort of data, a number of iterations can be performed in a pipelined manner for faster performance. As described hereinafter, a stable sort is a type of sorting method that preserves the relative order of elements with equal keys or values. In other words, if two elements have the same key or value, their order in the sorted output will remain the same as their order in the original input. Common prefix-stable sorting methods include stable variants of popular sorting methods such as merge sort, bubble sort, and insertion sort. These methods achieve stability by ensuring that elements with equal keys are not reordered during the sorting process.

In one example, combining the functionalities of the circuits described herein can provide for a fully pipelined BVH builder that supports building smaller, localized versions of a traditional BVH, hereinafter referred to as BVH treelets. As described, each iteration of sorting and reduction of data creates one or more levels of a BVH treelet at a time. Compared to a software-only solution, the solutions presented herein delegate more expensive processing steps to hardware. It also minimizes memory access latencies, thereby increasing overall ray tracing system efficiencies.

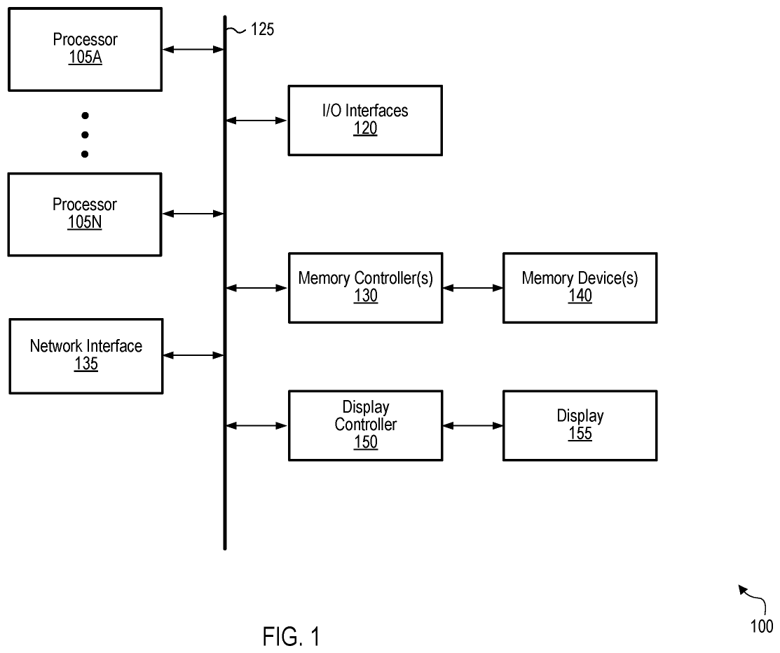

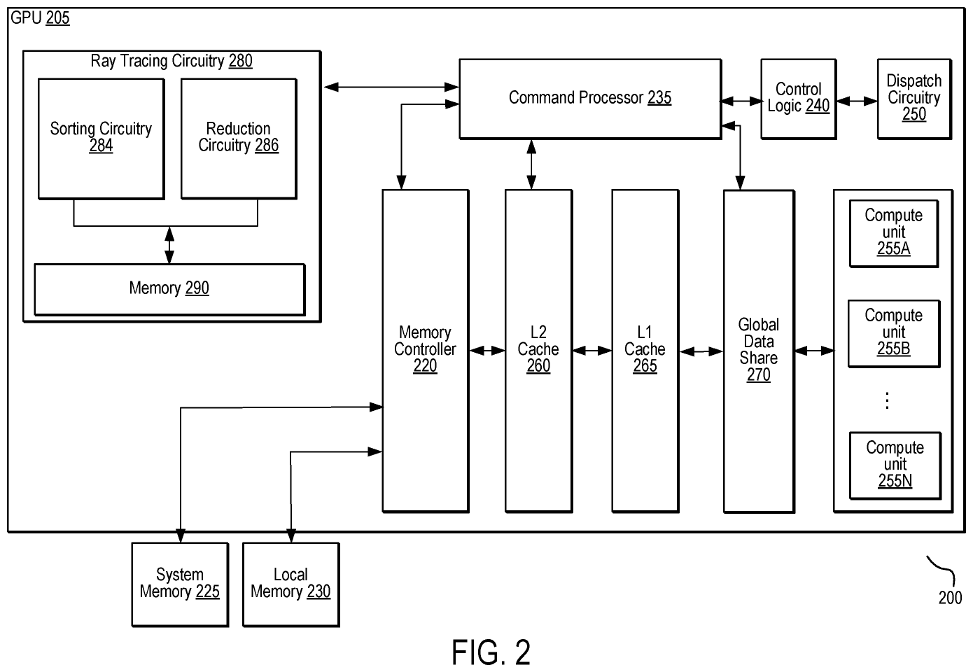

Referring now to FIG. 1, a block diagram of one implementation of a computing system 100 is shown. In an implementation, computing system 100 is configured to, amongst other functionalities, render a scene using ray tracing for creating highly realistic images. The computing unit 100 is configured to casting rays from a camera's viewpoint into a scene and trace the paths of these rays to determine how they interact with the objects and light sources. Further, computing system 100 is configured to perform reduced-precision ray triangle or ray box intersection tests that complement full-precision tests to detect primitives that are intersected or missed by a given ray. These intersection tests are explained in detail with respect to subsequent FIGS. 2-5.

In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 2-5 herein.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

Turning now to FIG. 2, a block diagram of an implementation of a computing system 200 is shown. In one implementation, system 200 includes GPU 205, system memory 225, and local memory 230. System 200 also includes other components which are not shown to avoid obscuring the figure. GPU 205 includes at least command processor 235, control logic 240, dispatch unit 250, compute units 255A-N, memory controller 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes ray tracing circuitry 280 including sorting circuitry 284, reduction circuitry 286, and memory 290. In the example shown, ray tracing circuitry 280 is shown as part of the GPU 205. However, in other implementations, one or more elements of the illustrated ray tracking circuitry 280 may be external to the GPU 205. In some implementations, one or more elements of ray tracking circuitry 280 may be implemented by one or more programmable logic devices such as field programmable gate arrays (FPGAs). Various such implementations are possible and are contemplated.

In various implementations, computing system 200 executes any of various types of software applications. As part of executing a given software application, a host CPU (not shown) of computing system 200 launches kernels to be performed on GPU 205. Command processor 235 receives kernels from the host CPU and uses dispatch unit 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N.

In one implementation, ray tracing circuitry 280 implements ray tracing to enable GPU 205 to render a three-dimensional (3D) scene by using an acceleration tree structure (referred to as a bounding volume hierarchy or BVH). This can include performing ray tracing operations, including testing for intersection between light rays and objects in a scene geometry. In some implementations, much of the work involved in ray tracing is performed by programmable shader programs, executed on the compute units 255A-N. In an implementation, BVH structures are formed by the command processor 235 and are stored in system memory 225 and/or local memory 230. For example, a hierarchical tree is loaded into a memory, and the command processor 235 further executes operations to optimize the hierarchical tree. Once a given BVH is optimized or otherwise ready, ray intersection tests are performed and the ray tracing circuitry 280 uses the optimized BVH to test ray intersections in a given scene geometry. These tests are used by shader programs running on the compute units 255A-N to generate images using ray tracing accelerated by the optimized BVH. The updated images are then stored or otherwise made available for display on a display device.

In various implementations, traditionally specific computational tasks associated with BVH construction are performed in software, e.g., utilizing the CPU or GPU 205. BVH construction methods are implemented using software on these processors, leveraging their general-purpose computing capabilities. For instance, CPUs with multiple cores can exploit multithreading techniques to parallelize certain parts of the BVH construction process, improving performance. Further, the GPU 205, originally designed for graphics rendering, can also possess massively parallel architectures suited for BVH construction. However, software methods for BVH construction, e.g., sorting operations using quicksort or mergesort, can have average-case time complexities of O(n log n), which can become a bottleneck for very large datasets. For certain methods, worst-case scenarios might degrade to O(n\hat{ }2), impacting performance. Further, sorting methods often require additional memory space for temporary storage during the sorting process. This overhead can be significant for large datasets, especially in-place sorting methods that might need additional memory for sorting. Traditional sorting methods are also inherently sequential in nature and might not fully leverage the parallel processing capabilities of modern multi-core CPUs or GPUs. This limitation can result in suboptimal performance, especially on systems with high parallel processing capabilities.

To mitigate issues arising due to these operations executed using software methods, implementations described herein disclose specific hardware circuitries programmed to perform these operations to mitigate memory bandwidth issues and reduce the amount of memory bandwidth required by synchronization operations, thereby enabling faster and more efficient construction of hierarchical acceleration structures. In an implementation, ray tracing circuitry 280, as described herein, includes specialized hardware components or dedicated processing units designed to accelerate BVH construction.

In an implementation, ray tracing circuitry 280 uses hardware acceleration to perform sorting and reduction of geometrical primitives for building acceleration structures such as BVH. According to the implementation, the sorting circuitry 284 sorts primitives (such as triangles or other geometric shapes representing objects in a scene) using parallel processing techniques. In one example, sorting circuitry 284 sorts primitives based on their spatial attributes, such as bounding box centroids or other spatial properties, to facilitate efficient spatial subdivision. Once the primitives are sorted, these are spatially partitioned to form the hierarchy. This partitioning process involves dividing the sorted primitives into groups based on a spatial criterion, such as splitting along the median or using space-filling curves like Morton encoding.

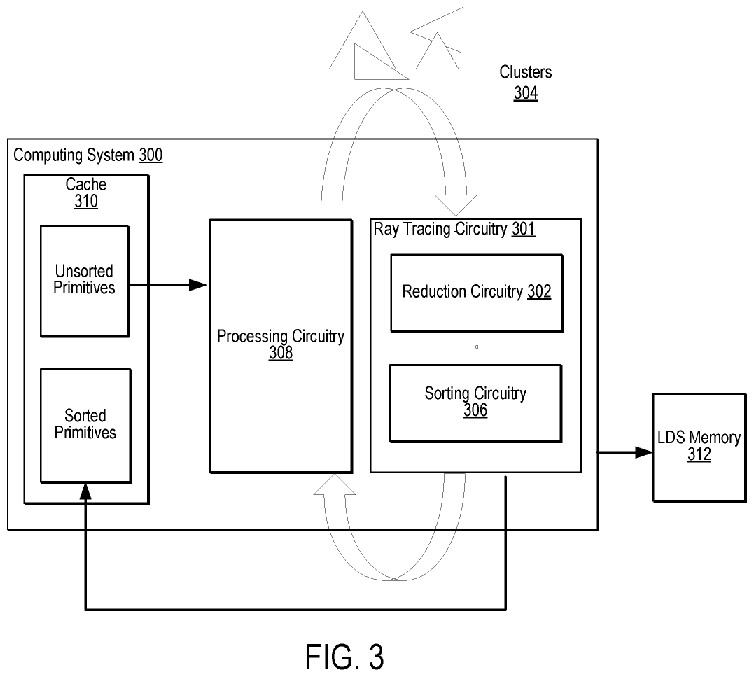

In an implementation, the spatial partitioning process results in the construction of the BVH hierarchy. This hierarchy is organized as a tree structure, where each node represents a bounding volume enclosing a group of primitives. Non-leaf nodes in the hierarchy contain references to child nodes or primitives, while leaf nodes directly store or reference the primitives. In an implementation, as the BVH hierarchy is constructed, the number of primitives per leaf node can be reduced to optimize traversal efficiency. This reduction can be performed by the reduction circuitry 286, and can involve merging adjacent leaf nodes or combining primitives within a node to achieve a target leaf size. The sorting and reduction operations performed by components of the ray tracing circuitry 280 are described in further detail with respect to FIG. 3. In one implementation, unprocessed primitives (e.g., before these are processed by the ray tracing circuitry 280) can be stored in memory 290, and various operations, such as sorting and reduction operations described herein are performed on these primitives. Further, post-processed primitives can again be stored in memory 290, e.g., to be accessed by the GPU 205 for further proceeding during BVH construction.

In one implementation, the ray tracing circuitry 280 comprises specialized hardware circuits, such as sorting circuitry 284 and reduction circuitry 286, to handle specific tasks within the BVH build pipeline, such as sorting, partitioning, or reduction, that exploit parallelism and accelerate processing related to BVH construction.

In one implementation, each compute unit 255A-N can include one or more SIMD units (not shown), which execute operations concurrently in response to requests from the GPU 205, following a SIMD paradigm. This paradigm involves multiple processing elements sharing a single program control flow unit and program counter, thereby executing the same program while processing different data. For instance, each programming lane within a SIMD unit executes identical instructions simultaneously, albeit with distinct data inputs. Predication allows for the deactivation of programming lanes if not all are required for executing a particular instruction, enabling execution of programs with divergent control flow. Specifically, for programs involving conditional branches or instructions where control flow depends on calculations performed by individual lanes, predication enables the execution of different control flow paths, leading to flexible control flow. As described herein, a “programming lane” generally represents an individual processing unit or a computational pathway within a SIMD architecture. In such architectures, multiple lanes or processing units execute the same instruction simultaneously on different portions of data.

As shown in the implementations described in FIG. 2, the ray tracing circuitry 280 is integral to the GPU 205. In one example the ray tracing circuitry 280 can be programmed as an additional circuitry in communication with the command processor 235. In another example, multiple hardware circuitries can be programmed to perform the functions of the ray tracing circuitry 280, e.g., as individual circuitries (not shown) included within each compute unit 255, in addition to one or more existing ray accelerators (not shown). In these implementations, one or more functions of the ray tracing circuitry, e.g., functions that are described to be performed by the sorting circuitry 284 and/or the reduction circuitry 286, can be performed by individual SIMD units programmed within each compute unit 255.

In another implementation, the ray tracing circuitry 280 can also be programmed as a standalone circuitry within the system 200, however external to the GPU 205, such that the ray tracing circuitry 280 communicates with the GPU 205 to leverage the processing capabilities of the GPU 205 to perform one or more operations, such as but not limited to, data partitioning, calculation of bounding boxes, BVH optimizations, and memory management. Other implementations are contemplated.

As shown in FIG. 3, computing system 300 includes components similar to the components described for system 200 in FIG. 2, however, some components have been omitted for the sake of brevity. The computing system 300 depicted in FIG. 3, at least comprises a processing circuitry 308 (e.g., GPU 205 of FIG. 2), and ray tracing circuitry 301 (corresponding to ray tracing circuitry 280 described in FIG. 2). The ray tracing circuitry 301 further includes sorting circuitry 306 and reduction circuitry 302. In an implementation, system 300 further includes a cache memory 310, to store initial unsorted geometrical primitives as well as sorted geometrical primitives post processing by the ray tracing circuitry 301.

In operation, reduction circuitry 302 is configured to obtain a set of unsorted geometrical primitives, e.g., divided into a set of clusters 304. In an implementation, the primitives are initially divided into the set of clusters 304 by dividing the primitives into equal or nearly equal subsets based on a chosen splitting plane. For instance, dividing the primitives based on a splitting plane can include selecting a plane in 3D space and dividing the primitives into two subsets based on their position relative to this plane. Primitives intersecting or lying on one side of the plane are grouped into one subset, while those on the other side belong to the second subset. This partitioning continues recursively, with each subset further divided using additional splitting planes until termination conditions are met. In another implementation, the primitives can also be initially clustered based on a Surface Area Heuristic (SAH) method by considering the surface area of bounding volumes and choosing a split that minimizes the expected traversal cost of the resulting BVH.

In an implementation, the unsorted and non-clustered geometrical primitives can be initially stored in the cache memory 310 (e.g., items that need to be quickly sorted), as depicted. These primitives are then processed by the processing circuitry 308 to select the datum by which to do the sorting and reduction. Starting with unprocessed geometrical primitives in a given scene, the processing circuitry 308 uses the reduction circuitry 302 to determine a subdivision or clustering criterion. The processing circuitry then uses the sorting circuitry 306 to sort the geometry according to a given spatial axis, and in a subsequent sorting step is reconstructs the clusters using the sorting circuitry 306. It then determines the subdivision points and the process repeats. This criterion could be based on geometric properties (like centroid, bounding box, etc.) or cost-based heuristics. In one implementation, the reduction circuitry 302 further performs a reduction operation on each cluster 304, e.g., to determine a longest axis within a given space or bounding volume. For instance, the reduction circuitry 302 is configured to first compute extents along all axes for a set of primitives in each cluster 304, in order to determine extents along each axis (X, Y, Z). Extents represent the minimum and maximum coordinates of the primitives along each axis. In one implementation, the reduction operations include partial reductions, that is, when organizing primitives within a specific node or cluster 304, partial reductions are performed that compute properties like the bounding volume's size, centroid, or other relevant statistics from the primitives contained in that cluster 304.

In one implementation, the sorting circuitry 306 as well as the reduction circuitry 302 is configured to perform operations on floating numbers and/or integer values. According to the implementation, the processing circuitry 308 is configured to determine how the primitives are represented using floating or integer values, as well as to determine the values to be inputted to the sorting circuitry 306 and the reduction circuitry 302. For example, the processing circuitry determines that an input for the reduction circuitry 302 comprises 4 triangles (A, B, C, and D), that are divided into 2 clusters (a first cluster containing ABC and a second cluster containing D). Based on this input, the reduction circuitry 302 is configured to reduce all triangles by their minimum and maximum values, e.g., by extracting the x-axis values for each triangle. Further, the sorting unit 302 can obtain these values and generates the values for minimum and maximum values for each cluster, i.e., min (ABC), max (ABC), min(D) and max(D). That is, the processing circuitry 308 is programmed to determine whether reduction is to be performed by the minimum or maximum value along the x-axis. Based on this determination, the minimum x-value and the maximum x-value of each triangle is inputted into the reduction circuitry 302. In an implementation, the reduction circuitry 306 calculates the minimum value across all values in a cluster 304. Alternatively, the calculation of maximum and minimum values can be performed by the reduction circuitry 302 itself. This calculation is repeated for each axis (x, y, z) or can be performed by the reduction circuitry 302 simultaneously.

The reduction circuitry 302 calculates the lengths of each axis, e.g., by subtracting the minimum value from the maximum value for each axis. This yields the lengths or sizes of the space along the x, y, and z axes. A reduction operation (such as finding the maximum value among the axis lengths) is then applied to determine which axis has the longest length or extent. The reduction operation iterates through the lengths of the axes and selects the axis with the maximum length, indicating the longest axis within the given set of primitives or bounding volumes. Further, once the reduction operation is completed, the axis identified with the maximum length indicates the dominant or longest axis within the spatial extent of the primitives. The determined longest axis can be utilized, e.g., in spatial partitioning or node splitting, to guide the subdivision of space along the most significant axis.

In an implementation, based on the calculated lengths of each axis, the processing circuitry 308 determines a “split axis,” i.e., an axis that is selected for splitting a given cluster. Referring to the above example, the cluster containing triangles ABC can be selected to be split using the x-axis (e.g., determined as the longest axis). In order to do so, the triangles within the cluster need to be sorted. In one implementation, geometrical primitives within each cluster 304 are sorted by the sorting circuitry 306, in a first sorting operation using the determined longest axis as a first sorting key. According to the implementation, the sorting circuitry 306 is programmed to associate each primitive with its corresponding bounding box and identify the longest axis for each bounding box. The sorting circuitry 306 creates a list of tuples, pairing each primitive with its bounding box and the identifier of the longest axis. Then, sorting circuitry 306 executes a stable sorting program to sort these tuples primarily based on the identified longest axis. Stable sorting, as described herein, refers to a sorting technique that maintains a relative order of the primitives with equal values of sort keys even after sorting. In other words, if two primitives have the same value of a sort key in the original sequence, a stable sorting ensures that their relative positions remain the same in the sorted sequence, as they were in the initial unsorted sequence.

In one implementation, the sorting process groups primitives based on their longest axis. For example, primitives with their longest axis as the x-axis will be grouped together, followed by primitives with the y-axis as their longest axis, and so on. Within each group of primitives sharing the same longest axis, the original order of primitives should be maintained. This ensures that primitives with similar spatial orientation are likely to be near each other in the sorted list.

In an implementation, the sorting circuitry 306 uses a prefix sum, or prefix scan, for spatial sorting or partitioning primitives efficiently. In BVH construction, spatial sorting is often used to organize primitives along different axes (such as x, y, or z) or dimensions. By utilizing prefix sum, the sorting circuitry 306 can determine the order or positions of primitives after sorting along a specific axis. Further, based on sorting the primitives along an axis, the prefix sum operation can calculate the prefix sum array, where each element represents the cumulative sum of the primitives' counts before a given index. This information can be used to efficiently divide the primitives into subsets or nodes during the BVH construction process. Further, utilizing prefix sums in sorting primitives during BVH construction, the sorting circuitry 306 can enable efficient computation of cumulative sums in parallel, which can speed up sorting and partitioning operations for large sets of primitives.

Referring to the above example, the sorting circuitry 306 sorts the cluster containing triangles ABC using x-axis as the longest axis. The input to the sorting circuitry 306 is the x-value of each triangle, such that the sorting circuitry 306 sorts ABCD by their respective x-values. In one example, a result of such sorting yields the triangle in the order “ADCB”. Each triangle is then again sorted by their cluster ID, i.e., the ID of respective cluster each triangle is a part of used as a second sort key. Using cluster ID, in one example, the result of such sorting can yield the first cluster sorted as ACB and the second cluster would remain unchanged (since it only has a single triangle D). Based on this sorting, the processing circuitry 308 can split the first cluster (having triangles ordered as ACB) into two sub-clusters (e.g., a first cluster having triangles AC and the second sub-cluster having triangle B). The second cluster remains unchanged (i.e., contains the triangle D).

In one implementation, the sorting circuitry 306 is programmed using a SIMD architecture as described in FIG. 2. In the implementation, using the SIMD architecture, the sorting circuitry 306 is programmed in a manner that re-sorting the primitives using the cluster ID as the second sorting key, automatically generates “cluster leaders” without any operational costs, e.g., representing a centroid of a given cluster 304 or data points within a cluster 304 that are most centrally located or representative of the cluster 304. In an implementation, iteratively sorting the primitives using cluster IDs produces “run starts,” and the processing circuitry 308 can notify each programming lane in the SIMD architecture that is identified as a group leader. This acts as a split across the clusters 304. For example, by sorting the primitives using cluster IDs, the sorting circuitry 306 can determine a start point of each cluster 304, since the sorting is performed using a counting sort that can compute how many primitives each cluster 304 contains. Further, using the prefix sum operation, the sorting circuitry 306 is able to determine the start point of each cluster 304.

In an example, sorted primitives and associated clusters are iteratively reduced and sorted, as described above, till a termination condition is met. The termination condition can include reaching a maximum number of primitives in each cluster 304 and/or reaching a minimum number of clusters 304. In one implementation, each time primitives are sorted within a cluster, new clusters can be generated and/or existing clusters can be modified.

In an implementation, at a given time during the iterative reduction and sorting of primitives in clusters 304, one or more clusters can be discarded from consideration. For instance, empty or insufficiently populated nodes can be terminated and/or nodes can be pruned for further optimization of the hierarchical structure. In one implementation, the sorting circuitry 306 can execute “wave wide” sort operations. Wave-wide sort operations can include sort operations performed concurrently across all threads within a wave. In a wave, a single instruction can be broadcast and executed across all threads simultaneously. Wave-wide operations can be well-suited for SIMD computations. In an implementation, primitives that are sorted using wave-wide operations, can be discarded from “group-wide” sorting operations, i.e., operations performed among threads within a work-group (thread block). This way, certain clusters 304 from the data set are removed and BVH construction is further optimized and can be performed faster.

In one or more implementations, for a group-wide sorting mechanism, the sorting circuitry 306 requires passing through all data, and scales with the number of clusters 304 being sorted. However, if each sorted cluster is confined to a single wave (e.g., later in the sorting process), cross-wave synchronization can be avoided and the sorting can be performed per wave instead. In an implementation, sorting within a wave can be implemented cheaper than a group-wide sorting operation, e.g., a counting sort may only need 5-bit counters, thereby reducing cost associated with sorting operations. In one implementation, the sorting circuitry 306 is configured to switch from the sorting operations described herein to wave-local sorting operations at a predetermined point in the BVH build process, based on specific applications and associated operational costs.

In one implementation, data generated as a result of the recursive sorting and reduction operations, performed by the sorting circuitry 306 and reduction circuitry 302, respectively, is moved to a local data share memory (memory 312). According to the implementation, storing this data after each sort/reduction operation (data such as cluster information, cluster IDs, number of primitives, source address, and destination address) ensures that memory accesses and associated latencies associated with retrieving data can be avoided. Further, this also makes the operations more efficient since regeneration of sorting data is avoided with the use of the memory 312. Since the sorting and reduction operations are performed per-cluster, and iteratively until a termination condition is met, storing the intermediate data that results from these operations can substantially increase the speed of BVH construction. Finally, sorted primitives representing nodes of the BVH are stored in the cache memory 310, from where it can be accessed by processing circuitry 308 for further processing, such as rendering operations.

In one implementation, the sorted primitives are grouped as nodes to construct a BVH or other spatial structures. The sorted order of the primitives assists in optimizing the arrangement of primitives within the nodes or spatial partitions. It further helps in creating balanced hierarchies, where neighboring primitives in space are likely to be in the same or nearby nodes, reducing traversal and intersection test times.

In various implementations, reduction of clusters using the reduction circuitry 302 and iterative sorting of primitives by the sorting circuitry 306, creates a pipelined system that can output the cluster leads at the same time sorting results are generated. Further, by using the prefix sum stable sorting of primitives, the sorting circuitry 306 can be programmed to perform a number of iterations in a pipelined manner for faster performance. Combining the functionalities of the circuits described herein can provide for a fully pipelined BVH builder, such that every iteration of sorting and reduction operations, creates one or more levels of a BVH at a time.

In various implementations, BVH building requires repeated sorting of the data, partitioning of sorted data, and reductions within clusters. The hardware implementations described herein can be used to sort partitioned data and make reductions for each partition. This allows for the initial sorting along an axis and calculation of bounding box extents to be performed as hardware operations. Further, the only processing left for software execution is the selection of the split axis, and setting up the sorting keys and iteration. The solutions described herein will improve the performance of BVH builds, especially for cases where the geometry is comprised of many small treelets. Compared to a software-only solution, the systems described execute the most expensive steps which require a lot of cross-wave communication, but no program control, by using specific hardware. It also minimizes memory traffic, since all requisite data can be stored in an internal memory of the sorting circuitry, instead of multiple DMA requests between register files and sorting circuitry.

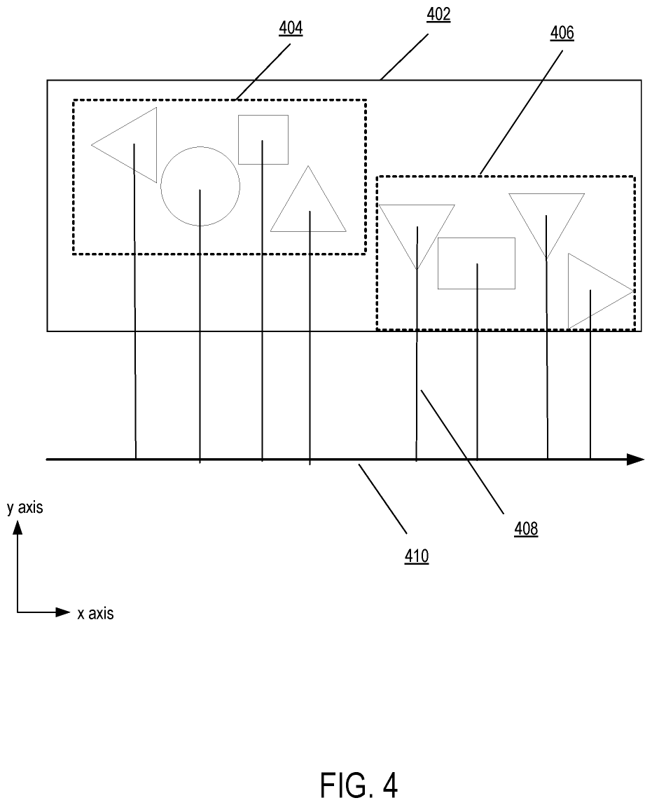

FIG. 4 illustrates a graphical representation of grouping of primitives into clusters. In an implementation, a cluster 402 comprising multiple primitives (such as triangles), e.g., eight triangles, is divided into two clusters: cluster 404 and a cluster 406. The collection of primitives linked by the cluster 404 and the cluster 406 undergoes iterative division. This subdivision continues until a termination condition is met, e.g., until the cluster contains fewer than or equal to a number of primitives or there are enough triangles to form a leaf nodes. In an implementation, each cluster can have a maximum size (i.e., starting with a single cluster containing all triangles and gradually dividing them into smaller clusters). For example, an input cluster can contain 1024 triangles to be processed, and the target cluster size can be 16. That is the processing of primitives begins with one large cluster of 1024 triangles and the cluster can be subdivided until no cluster has more than 16 primitives left.

In one implementation, the clusters can be created based on a Surface Area Heuristic (SAH) of the clusters. Using the SAH, the cluster 404 can be generated as containing n primitives, and n−1 split positions at each primitive centroid 408. At each split position, the primitives can be divided into two distinct subsets. The split positions are evaluated based on a cost based on SAH, and the final subdivision occurs at the position with the lowest overall cost. In an implementation, the process of subdividing each cluster involves arranging primitives in spatial order. This means organizing primitives along their x, y, and z axes, labeled as dimensions 410. To elaborate, when sorting along the x, y, or z axis, all potential split positions are considered. For example, when n represents the quantity of primitives within the cluster's range, during this iteration, n−1 split positions are assessed.

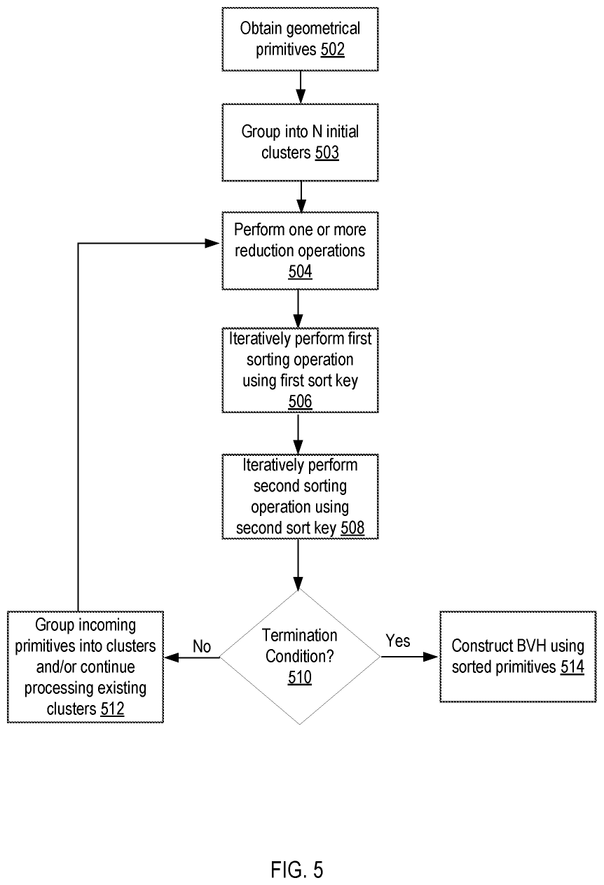

FIG. 5 illustrates a method for building a hierarchical acceleration structures based on geometrical primitives. In an implementation, generating a hierarchical structure, such as a Bounding Volume Hierarchy (BVH) using geometrical primitives involves constructing a hierarchical data structure that organizes the primitives into a tree-like arrangement of bounding volumes. The BVH represents these geometric elements for various computational purposes, such as collision detection, ray tracing, or spatial partitioning.

The geometrical primitives, such as triangles, represented by their geometric properties, such as vertices, edges, etc. are obtained by a BVH builder (block 502). In one implementation, the sorting circuitry and reduction circuitry as described in the foregoing is cumulatively referred to as a BVH builder herein. In an example, these primitives can be obtained as inputs from 3D models, or objects representing a scene obtained from rendering or simulation applications. In an implementation, initially, these primitives are received as an unordered data set and are grouped into ‘N’ initial clusters (block 503). The BVH builder is configured to perform one or more reduction operations on each cluster (block 504). In one implementation, wherein the reduction operations are performed to generate sorting keys to sort the set of geometric primitives comprised within each cluster. In one example, the reduction operations are performed to find the longest axis of each cluster, such that the longest axis can be used by the BVH builder to sort the primitives comprised within each cluster. Generation of other sort keys is possible and is contemplated. In one implementation, the reduction operations include partial reductions, that is, when organizing primitives within a specific node or cluster, partial reductions are performed compute properties like the bounding volume's size, centroid, or other relevant statistics from the primitives contained in that cluster.

In one implementation, the BVH builder performs a first sorting operation using a first sort key (longest axis) to sort the primitives within each cluster (block 506). In one example, the sorting is performed as a stable sort operation utilizing a prefix sum. Stable sorting refers to a sorting technique that maintains a relative order of the primitives with equal values of sort keys after sorting. In other words, if two primitives have the same value in the original sequence, stable sorting ensures that their relative positions remain the same in the sorted sequence, as they were in the initial unsorted sequence. Further, as described in the foregoing, by utilizing prefix sum, the BVH builder can determine the order or positions of primitives after sorting along a specific axis (e.g., the longest axis determined by the reduction operation). Based on sorting the primitives along the longest axis, the prefix sum operation can calculate the prefix sum array, where each element represents the cumulative sum of the primitives' counts before a given index. This information can be crucial for efficiently dividing the primitives into subsets or nodes during the BVH construction process.

In one implementation, each time primitives are sorted within a cluster, new clusters can be generated and/or existing clusters can be modified. The BVH builder then iteratively sorts the primitives using a second sorting key (block 508). In one implementation, the second sorting key is based on cluster IDs of clusters created after the primitives are sorted using the first sort key. Based on sorting operations using the second sort key, cluster leaders are automatically generated. Further each processing lane that is a cluster group leader can be notified. This acts as a split across the clusters.

The BVH builder can periodically check whether a termination condition is reached (conditional block 510). In an implementation, the termination condition can include a maximum number of primitives in each cluster being reached and/or a minimum number of clusters are generated. In another implementation, sorting operations can further be terminated responsive to the cluster size being equal to or lesser than a threshold value. Responsive to the termination condition not being met (conditional block 510, “no” leg), the BVH builder continues to group incoming primitives into new clusters and/or processing existing clusters (block 512). However, if a termination condition is met (conditional block 510, “yes” leg), the BVH builder constructs the BVH using the sorted primitives (block 514) and transmits the BVH to a processing circuitry for further rendering operations.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
first processing circuitry configured to perform one or more reduction operations on a first set of data clusters to generate one or more sorting keys;
second processing circuitry at least in part comprising a plurality of single-instruction-multiple-data (SIMD) units, wherein one or more SIMD units are configured to iteratively sort, using the one or more sorting keys, a set of geometrical primitives represented in each data cluster of the first set of data clusters to generate nodes representing a hierarchical acceleration structure; and
wherein the first processing circuitry performs a rendering operation using the hierarchical acceleration structure.

2. The system as claimed in claim 1, wherein the one or more SIMD units are configured to repeatedly sort the set of geometrical primitives within each data cluster until a termination condition is met, the termination condition comprising at least one of reaching a maximum number of geometrical primitives in each data cluster, reaching a minimum number of data clusters, or a size of each data cluster in the first set of data clusters being less than or equal to a threshold.

3. The system as claimed in claim 1, wherein the one or more SIMD units are configured to generate, based at least in part on sorting the set of geometrical primitives by a first sort key, a data cluster leader from the first set of data clusters.

4. The system as claimed in claim 1, wherein the one or more SIMD units are configured to re-sort the geometrical primitives using a second sort key to generate a second set of data clusters.

5. The system as claimed in claim 4, wherein the second sort key is generated based at least in part on a cluster identifier associated with each data cluster.

6. The system as claimed in claim 1, wherein the one or more SIMD units are configured to sort the set of geometrical primitives by performing one of wave-wide sort operations and group-wide sort operations.

7. The system as claimed in claim 1, wherein the one or more reduction operations for a given data cluster at least in part comprise an operation performed to compute extents along each axis for a set of primitives in the given data cluster, wherein the extents along each axis represent minimum and maximum coordinates of the set of primitives along each axis.

8. A method comprising:
performing, by a reduction circuitry, one or more reduction operations on each data cluster of a first set of data clusters to generate one or more sorting keys;
iteratively sorting, by a sorting circuitry, using the one or more sorting keys, a set of geometrical primitives comprised in each data cluster to generate nodes representing a hierarchical acceleration structure; and
executing, by a rendering circuitry, a rendering operation using the hierarchical acceleration structure.

9. The method as claimed in claim 8, further comprising repeatedly sorting, by the sorting circuitry, the set of geometrical primitives within each data cluster until a termination condition is met, the termination condition at least in part comprising reaching a maximum number of geometrical primitives in each data cluster, reaching a minimum number of data clusters, or a size of each data cluster being less than or equal to a threshold.

10. The method as claimed in claim 8, further comprising generating, by the sorting circuitry, a cluster leader from the first set of data clusters, based at least in part on sorting the set of geometrical primitives by a first sort key.

11. The method as claimed in claim 8, further comprising re-sorting, by the sorting circuitry, the geometrical primitives, using a second sort key, to generate a second set of data clusters.

12. The method as claimed in claim 11, wherein the second sort key is generated based at least in part on a cluster identifier associated with each data cluster.

13. The method as claimed in claim 8, further comprising sorting, by the sorting circuitry, the set of geometrical primitives by performing one of wave-wide sort operations and group-wide sort operations.

14. The method as claimed in claim 8, wherein the one or more reduction operations for a given data cluster at least in part comprise an operation performed to compute extents along each axis for a set of primitives in the given data cluster, wherein the extents along each axis represent minimum and maximum coordinates of the set of primitives along each axis.

15. A graphics processing device comprising:
one or more processors each comprising a plurality of single-instruction-multiple data (SIMD) units, wherein the one or more processors are collectively configured to:
perform one or more reduction operations on each cluster of a first set of clusters to generate one or more sorting keys; and
iteratively sort, using one or more sorting keys, a set of geometrical primitives in each cluster of the first set of clusters to generate nodes representing a hierarchical acceleration structure to be processed by the at least one processing circuitry, wherein the sort is performed using a prefix sum stable sort operation
process the hierarchical acceleration structure.

16. The system as claimed in claim 15, wherein the one or more processors are collectively configured to repeatedly sort the set of geometrical primitives within each data cluster until a termination condition is met, the termination condition at least in part comprising reaching a maximum number of geometrical primitives in each data cluster, reaching a minimum number of data clusters, or a size of each data cluster being less than or equal to a threshold.

17. The system as claimed in claim 15, wherein the one or more processors are collectively configured to generate, based at least in part on sorting the set of geometrical primitives by a first sort key, a cluster leader from the first set of data clusters.

18. The system as claimed in claim 15, wherein the one or more processors are collectively configured to re-sort the geometrical primitives using a second sort key to generate a second set of data clusters.

19. The system as claimed in claim 15, wherein the one or more processors are collectively configured to sort the set of geometrical primitives by performing one of wave-wide sort operations and group-wide sort operations.

20. The system as claimed in claim 15, wherein the one or more reduction operations for a given data cluster at least in part comprise an operation performed to compute extents along each axis for a set of primitives in the given data cluster, wherein the extents along each axis represent minimum and maximum coordinates of the set of primitives along each axis.
